(19) United States
(12) Patent Application Publication
(10) Pub. No.: US 2020/0250805 A1
(43) Pub. Date: Aug. 6, 2020

(54) IMAGE INSPECTION DEVICE, IMAGE FORMATION DEVICE, IMAGE INSPECTION METHOD, AND NON-TRANSITORY RECORDING MEDIUM STORING A COMPUTER READABLE PROGRAM

(71) Applicant: KONICA MINOLTA, INC., Tokyo (JP)

(72) Inventor: Yasumasa TSUKAMOTO, Tokyo (JP)

(73) Assignee: KONICA MINOLTA, INC., Tokyo (JP)

(21) Appl. No.: 16/747,855

(22) Filed: Jan. 21, 2020

(30) Foreign Application Priority Data
Feb. 5, 2019 (JP) 2019-018549

(51) Int. Cl. G06T 7/00

(52) U.S. Cl. CPC G06T 7/0002; G06T 2207/10008; G06T 2207/30168; G06T 2207/30176

(57) ABSTRACT

To perform an image inspection even when an image formation device performs image processing or image editing. An image inspection device according to one aspect of the present invention includes: an image reader that reads a sheet formed with an image formed by an image former to acquire a read image; a document image acquisition portion that acquires a document image; an inspection target region specifier that specifies a print region in a recording material based on an image formation condition for a document image and specifies an inspection region in the read image based on the specified print region; and an image inspector that compares an image in an inspection region with an image in an inspection-region comparable region corresponding to the inspection region in the document image.

### CROSS-REFERENCE TO RELATED APPLICATIONS

The entire disclosure of Japanese Patent Application No. 2019-18549, filed on Feb. 5, 2019, is incorporated herein by reference in its entirety.

### BACKGROUND

### Technological Field

The present invention relates to an image inspection device, an image formation device, an image inspection method, and a non-transitory recording medium storing a computer-readable program.

### Description of the Related Art

Until now, there has been known an image inspection device that defines a document image as a correct image (reference image), defines a read image acquired by reading a printed material output from an image formation device as an inspection image, and compares the reference image with the inspection image to inspect the finish of the printed material.

When an image formation condition included in a print job specifies settings such as trimming, folioing, and image shift, a read image acquired by reading a printed material reflecting these settings differs from a document image in the contents.

With reference to FIG. 1, the description below illustrates the difference between the document image and the read image. The left part of FIG. 1 shows document image Po10 containing printed image “1” and document image Po20 containing printed image “2.” The right part of FIG. 1 illustrates a print image generated by an image formation device that applies image processing or image editing to document images Po10 and Po20. The print image at the right of FIG. 1 shows that document images Po10 and Po20 are imposed based on a 2in1 layout per sheet. The print image is provided with a margin added and contains page numbers such as “-1-” and “-2-” at the bottom center of each page.

When the image formation device performs image processing or image editing, the read image acquired by reading an image to which the image processing or the image editing is applied, for example differs from the document image to which the image processing or the image editing is not applied, for example, in the contents. The document image and the read image cannot be directly compared, making image inspection impossible.

For example, JP-2017-121769 A (Patent Literature 1) discloses the technology that applies image processing or image editing to image data as a document image, generates image-processed image data, and compares the image-processed image data with read image data acquired by reading an image formed on a sheet. The technology described in Patent Literature 1 defines image-processed image data as a reference image and defines a read image as an inspection image, making it possible to compare both.

### CITATION LIST

### Patent Literature

Patent Literature 1: JP 2017-121769 A

### SUMMARY

As image formation devices increase processing speeds, there is increasing use of the image formation device that performs image processing by using hardware such as ASIC (Application Specific Integrated Circuit) capable of high-speed processing without the use of software-based time-consuming image processing. Such an image formation device does not generate a print image in the memory while the print image is substantially printed on a sheet. The image formation device using the hardware for image processing cannot compare a document image with a read image when additional image processing or image editing is applied to the document image, making the image inspection impossible.

The present invention has been made in consideration of the foregoing. It is, therefore, an object of the present invention to successfully perform the image inspection even when an image formation device performs image processing or image editing.

To embody at least one of the above-described objects, according to an aspect of the present invention, an image inspection device according to one aspect of the present invention includes an image reader, a document image acquisition portion, an inspection target region specifier, and an image inspector, for example. The image reader reads a recording material formed with a document image based on an image formation condition to acquire a read image. The document image acquisition portion acquires the document image. The inspection target region specifier specifies a print region on a recording material based on an image formation condition for the document image acquired by the document image acquisition portion and specifies an inspection region in the read image based on the specified print region. The image inspector compares an image in the inspection region specified by the inspection target region specifier with an image in the inspection-region comparable region corresponding to the inspection region in the document image to perform image inspection on the read image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention;

FIG. 1 is a drawing illustrating a difference between a document image and a read image according to the prior art;

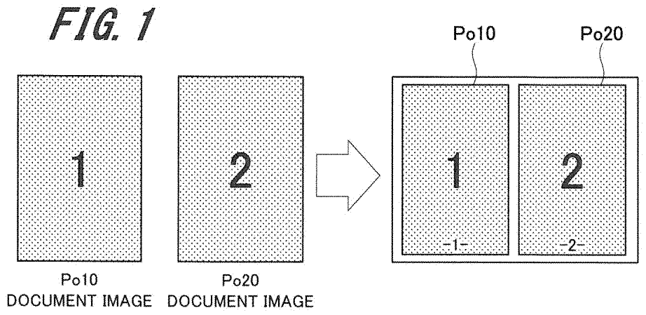

FIG. 2 is a schematic configuration diagram illustrating an overall configuration of the image formation system according to an embodiment of the present invention;

FIG. 3 is a control block diagram illustrating an internal configuration of major components of the image formation system according to an embodiment of the present invention;

FIG. 4 is a function block diagram illustrating a configuration example (1) of functional parts of the image formation system according to an embodiment of the present invention;

FIG. 5 is a function block diagram illustrating a configuration example (2) of functional parts of the image formation system according to an embodiment of the present invention;

FIG. 6 is a function block diagram illustrating operations of components configuring the functional part of the configuration example (1) of the image formation system according to an embodiment of the present invention;

FIG. 7 is a function block diagram illustrating operations of components configuring the functional part of the configuration example (2) of the image formation system according to an embodiment of the present invention;

FIGS. 8A to 8C are diagrams illustrating how an inspection target region specifier according to an embodiment of the present invention specifies an inspection region and an inspection-region comparable region;

FIG. 9 is a table illustrating an image formation condition according to an embodiment of the present invention;

FIGS. 10A to 10C are diagrams illustrating a method of specifying an inspection region and an inspection-region comparable region according to an embodiment of the present invention when a document image and a read image are differently oriented;

FIGS. 11A and 11B are diagrams illustrating a plurality of document images overlapping on a sheet according to an embodiment of the present invention;

FIG. 12 is a diagram illustrating how an inspection target region specifier according to an embodiment of the present invention specifies an inspection-region comparable region;

FIGS. 13A and 13B are diagrams illustrating an example of specifying an inspection region when an additional image is attached according to an embodiment of the present invention;

FIGS. 14A and 14B are diagrams illustrating an example of inspecting images when an additional image is attached according to an embodiment of the present invention; and

FIG. 15 is a flowchart illustrating a procedure of an image inspection method provided by the image formation system according to an embodiment of the present invention.

### DETAILED DESCRIPTION OF EMBODIMENTS

The description below explains the embodiments of the present invention with reference to the accompanying drawings. However, the scope of the invention is not limited to the disclosed embodiments. The present specification and drawings use the same reference numerals or symbols for constituent elements having substantially the same functions or configurations to omit a duplicate description of the constituent elements.

Overall Configuration of the Image Formation Device

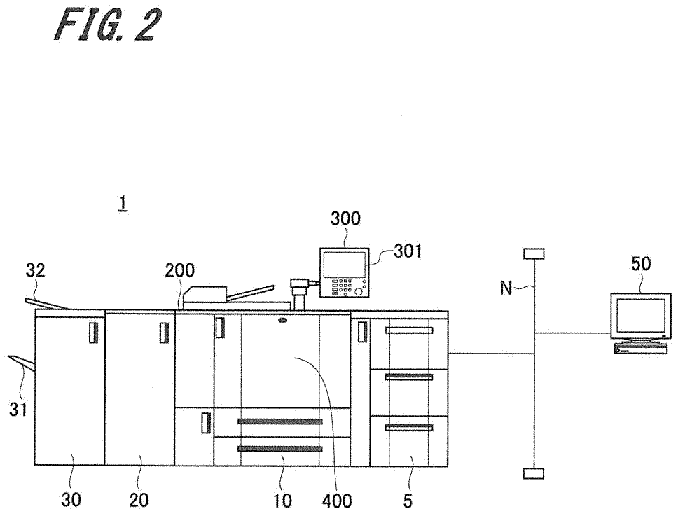

With reference to FIG. 2, the description below explains an overall configuration of the image formation system according to an embodiment of the present invention. FIG. 2 is a schematic configuration diagram illustrating an overall configuration of an image formation system 1 according to an embodiment of the present invention. FIG. 2 shows elements and related elements considered to be necessary for the description of the present invention. The image formation system according to the present invention is not limited to the example in FIG. 2.

As illustrated in FIG. 2, the image formation system 1 according to the present embodiment mainly includes an image formation device 10, a large-capacity paper feeder 5, an image inspection device 20, and a sheet ejector 30. The image formation device 10 is connected to an information terminal 50 via network N such as LAN. Based on manipulations by a user, the information terminal 50 supplies the image formation system 1 with a print job including a document image and an image formation condition, for example.

The large-capacity paper feeder 5 includes a plurality of sheet feed trays including a sheet feed mechanism. The sheet feed trays contain sheets (an example recording material) of different types and sizes. The different sheet feed trays may contain sheets of the same type or size. Sheets supplied from the sheet feed trays are transported to the image formation device 10 via an unshown transport path.

The image formation device 10 provides a digital multifunction machine equipped with the scanner function, the copier function, and the printer function and mainly includes a scanner portion 200, a manipulation/display portion 300, and an image former 400.

The scanner portion 200 optically reads an image from a document placed on an unshown document rack and applies A/D conversion to the read image to generate image data (scan data).

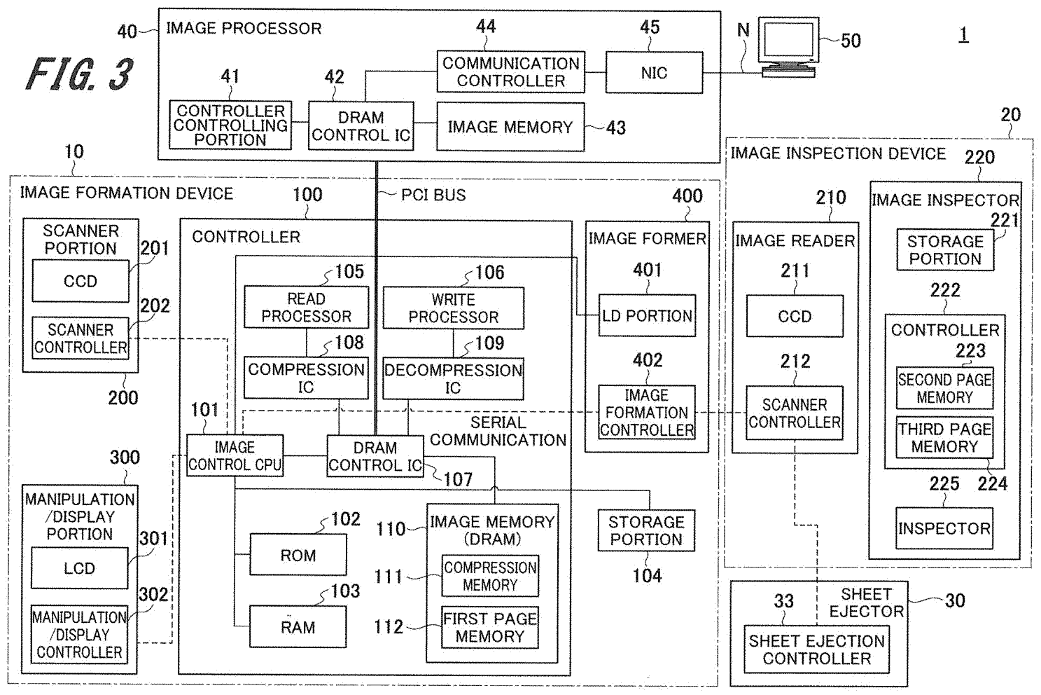

The manipulation/display portion 300 mainly includes an LCD (Liquid Crystal Display) 301, a manipulation key group, and a touch panel, for example. The manipulation/display portion 300 generates a manipulation signal representing the contents of user manipulation using the manipulation key group or the touch panel. The manipulation/display portion 300 supplies the manipulation signal to a controller 100 (see FIG. 3) to be described later. A controller 100 supplies a display signal. Based on this display signal, the manipulation/display portion 300 allows a display portion to display the contents of the user manipulation or setup information.

The image former 400 forms images on sheets supplied from the large-capacity paper feeder 5 based on a document image input from the information terminal 50 or image data read from the scanner portion 200.

An image reader 210 (see FIG. 3) reads a print sheet transported from the image formation device 10 to acquire a read image. A document image is input from the information terminal 50. The image inspection device compares the read image with the document image to perform an image inspection that inspects the finish of printed material.

The sheet ejector 30 includes a catch tray 31 for sheet ejection. The image inspection device 20 applies image inspection to a sheet that is transported and is ejected to the catch tray 31. The sheet ejector 30 includes a purge tray 32 to eject a sheet in which the image inspection device 20 detects an abnormality.

Internal Configuration of Major Components of the Image Formation System

With reference to FIG. 3, the description below explains an internal configuration of major components of the image formation system 1 according to an embodiment of the present invention. FIG. 3 is a control block diagram illustrating the internal configuration of major components of the image formation system 1.

As illustrated in FIG. 3, the image formation system 1 includes the image formation device 10, the image inspection device 20, the sheet ejector 30, an image processor 40. According to the present embodiment, the image processor 40 is configured to be independent of the image formation device 10. However, the present invention is not limited thereto. The image processor 40 may be configured to be built in the image formation device 10.

Configuration of the Image Formation Device

The image formation device 10 mainly includes the controller 100, a storage portion 104, the scanner portion 200, the manipulation/display portion 300, and the image former 400.

The controller 100 mainly includes an image control CPU 101, a ROM (Read Only Memory) 102, a RAM (Random Access Memory) 103, a read processor 105, a write processor 106, a DRAM (Dynamic Random Access Memory) control IC (Integrated Circuit) 107, a compression IC 108, a decompression IC 109, and an image memory (DRAM) 110.

The image control CPU 101 reads various types of processing programs such as a system program, an image formation processing program, and a sheet ejection processing program stored in the ROM 102 and loads these programs into the RAM 103. Based on the loaded programs, the image control CPU 101 centrally controls operations of components of the image formation device 10.

The ROM 102 is configured as a non-volatile memory such as semiconductor memory and mainly stores a system program corresponding to the image formation device 10 and various processing programs such as an image formation processing program and a sheet ejection processing program executable on the system program. These programs are stored as computer-readable program codes. The image control CPU 101 performs an operation corresponding to the program code as needed.

The RAM 103 provides a work area to temporarily store various programs executed by the image control CPU 101 and data related to the programs. The RAM 103 mainly stores job queues and various operation settings.

The read processor 105 applies various processes such as an analog signal process, an A/D conversion process, and a shading process to an analog image signal supplied from the scanner portion 200 to generate digital image data. The read processor 105 outputs the digital image data to the compression IC 108.

The write processor 106 generates a PWM (Pulse Width Modulation) signal based on image data supplied from the decompression IC 109 and outputs the PWM signal to the image former 400.

The DRAM control IC 107 receives (acquires) a print job transmitted from the DRAM control IC 42 of the image processor 40 and an image inspection start instruction to start the image inspection for example. The print job mainly includes a document image and information such as an image formation condition needed to form a document image on a sheet.

Under control of the image control CPU 101, the DRAM control IC 107 controls the compression IC 108 to compress image data, controls the decompression IC 109 to decompress the compressed data, and controls the image memory 110 to input and output image data. When the image control CPU 101 issues an instruction to save image data read by the scanner portion 200, for example, the DRAM control IC 107 allows the compression IC 108 to compress the image data supplied from the read processor 105 and allows a compression memory 111 of the image memory 110 to store the compressed image data.

When the image control CPU 101 issues an instruction to form an image for the compressed image data stored in the compression memory 111, the DRAM control IC 107 reads the compressed image data from the compression memory 111, allows the decompression IC 109 to perform the decompression, and allows a first page memory 112 to store the image data. Besides, the DRAM control IC 107 reads image data stored in the first page memory 112 and outputs the image data to the write processor 106.

The compression IC 108 compresses the supplied image data under control of the DRAM control IC 107. The decompression IC 109 decompresses the supplied compressed image data under control of the DRAM control IC 107.

The image memory 110 is comprised of DRAM as volatile memory, for example, and includes the compression memory 111 and the first page memory 112. The compression memory 111 stores compressed image data. The first page memory 112 temporarily stores compression-targeted image data for image formation before the image former 400 forms an image.

The storage portion 104 is comprised of HDD (Hard Disk Drive) or SSD (Solid State Drive), for example, and stores various setup data related to the image formation device 10. The storage portion 104 stores read image read by the image reader 210 of the image inspection device 20.

The scanner portion 200 optically reads image data from a document placed on an unshown document rack and includes a CCD (Charge Coupled Device) 201 and a scanner controller 202, for example. The CCD 201 converts the light reflected off the document into an electric signal. The scanner controller 202 controls operations of the CCD 201 and processes electric signals output from the CCD, for example.

The manipulation/display portion 300 mainly includes an LCD301 and a manipulation/display controller 302 as well as a manipulation key group and a touch panel, though unshown. Under control of the manipulation/display controller 302, the LCD 301 uses a monitor to mainly display various setup screens, image states, and operational situations of the functions.

Under control of the image control CPU 101, the manipulation/display controller 302 controls the display on the LCD 301. The manipulation/display controller 302 generates a manipulation signal based on the input manipulation from the touch panel on the LCD 301 or the manipulation key group and outputs the generated manipulation signal to the image control CPU 101.

The image former 400 provides an engine to perform a print process based on a document image included in a print job or image data to which an image formation controller 402 applied image processing or image editing. The image former 400 includes an LD (Laser Diode) portion 401 and the image formation controller 402, for example. The LD portion 401 irradiates a laser beam corresponding to an image onto a charged photosensitive drum and forms an electrostatic latent image. After the LD portion 401 forms the electrostatic latent image on the photosensitive drum, the electrostatic latent image undergoes a primary transfer and a secondary transfer and is printed on sheet Sh (image formation). An unshown fuser fuses the electrostatic latent image.

The image formation controller 402 provides the image former 400 with various controls to visualize electrostatic latent images and form images on sheets. Based on the image formation condition included in a print job, the image formation controller 402 applies mainly image processing or image editing such as trimming, folioing, and image shift to a document image included in the print job.

The image processor 40 connects with the DRAM control IC 107 of the controller 100 in the image formation device 10 via a PCI (Peripheral Components Interconnect) bus, for example. The image processor 40 performs image processing and functions as a controller to control the scanner portion 200 and the image former 400, for example.

According to the present embodiment, the image processor 40 mainly includes a controller controlling portion 41, a DRAM control IC 42, an image memory 43, a communication controller 44, and a NIC (Network Interface Card) 45.

The controller controlling portion 41 overall controls operations of components configuring the image processor 40.

The DRAM control IC 42 controls storing various data received via the NIC 45 and the communication controller 44 in the image memory 43 and reading data from the image memory 43. The DRAM control IC 42 connects with the DRAM control IC 107 of the controller 100 in the image formation device 10 via the PCI bus.

Under control of the controller controlling portion 41, the DRAM control IC 42 reads data targeted at image formation, namely, a document image, from the image memory 43 and transmits the document image to the DRAM control IC 107 of the image formation device 10. At this time, the DRAM control IC 42 also transmits the image formation condition to the DRAM control IC 107. The DRAM control IC 42 transmits an instruction to start the image inspection to the DRAM control IC 107.

The image memory 43 is comprised of DRAM, for example, and temporarily stores input data. The communication controller 44 controls communication of the NIC 45.

The NIC 45 provides a communication interface to connect with network N. The NIC 45 mainly receives print jobs transmitted from the information terminal 50 via network N and transmits a received print job to a DRAM control IC 602 of the image formation device 10.

Configuration of the Image Inspection Device

The image inspection device 20 mainly includes the image reader 210 and an image inspector 220. The image reader 210 mainly includes a CCD 211 and a scanner controller 212. The scanner controller 212 controls driving the components of the image reader 210 based on a control signal that is received from the image control CPU 101 via the image formation controller 402.

Specifically, the scanner controller 212 allows the CCD 211 to scan a sheet transported from the image formation device 10 and acquires an image (read image) the CCD 211 reads by scanning. The scanner controller 212 transmits the read image acquired from the CCD 211 to a controller 222 of the image inspector 220.

The sheet ejector 30 includes a sheet ejection controller 33. The sheet ejection controller 33 performs a process to eject sheets inspected by the image inspection device 20 to the catch tray 31 or the purge tray 32.

Internal Configuration of Functional Parts of the Image Formation Device and the Image Inspection Device

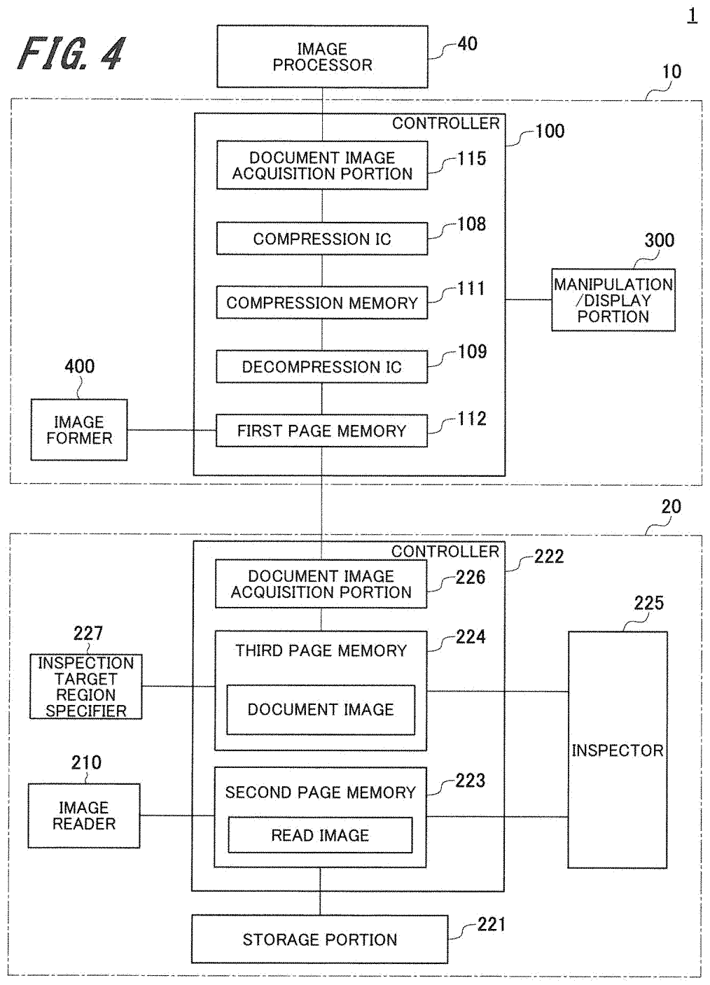

The description below explains the internal configuration by focusing on functional parts of the image formation device 10 and the image inspection device 20 configuring the image formation system 1. FIG. 4 is a function block diagram illustrating a configuration example (1) of functional parts of the image formation system 1.

Internal Configuration of the Functional Parts of the Image Formation Device

As illustrated in FIG. 4, the image formation device 10 mainly includes the controller 100, the manipulation/display portion 300, and the image former 400. The controller 100 mainly includes a document image acquisition portion 115, the compression IC 108, the compression memory 111, the decompression IC 109, and the first page memory 112.

The document image acquisition portion 115 receives the document image and the image formation condition contained in a print job supplied from the image processor 40 as illustrated in FIG. 3. Besides, the document image acquisition portion 115 passes the received document image to the compression IC 108.

There have been already described the compression IC 108, the decompression IC 109, the compression memory 111, and the first page memory 112 in the controller 100 and the image former 400 with reference to FIG. 3 and a description is omitted for simplicity.

Internal Configuration of the Functional Parts of the Image Inspection Device

As illustrated in FIG. 4, the image inspection device 20 mainly includes a storage portion 221, the controller 222, an inspection target region specifier 227, the image reader 210, and an inspector 225.

The controller 222 mainly includes a document image acquisition portion 226, a third page memory 224, and a second page memory 223.

The document image acquisition portion 226 acquires a document image stored in the first page memory 112 of the image formation device 10 and stores the acquired document image in the third page memory 224. The DRAM control IC 107 of the controller 100 illustrated in FIG. 3 provides the function of the document image acquisition portion 226, for example.

The second page memory 223 stores the read image acquired by the image reader 210.

The inspection target region specifier 227 specifies an inspection region in the read image and a region (described as an inspection-region comparable region) corresponding to the inspection region in the document image based on the image formation condition acquired by the document image acquisition portion 226. The image formation condition specifies the contents of various settings such as imposition, trimming, folioing (additional image), and image shift. The image control CPU 101 of the controller 100 illustrated in FIG. 3 provides the function of the inspection target region specifier 227, for example.

The inspector 225 identifies an inspection image and a reference image (correct image) based on an instruction to start the image inspection from the controller 222. The inspection image is contained in the read image stored in the second page memory 223. The reference image is contained in the inspection-region comparable region of the document image stored in the third page memory 224. The inspector 225 compares the inspection image with the reference image to perform an inspection (image inspection) to determine whether the image on printed material is abnormal.

The storage portion 221 stores a read image read by the image reader 210 and an inspection result of the image inspection performed by the inspector 225, for example.

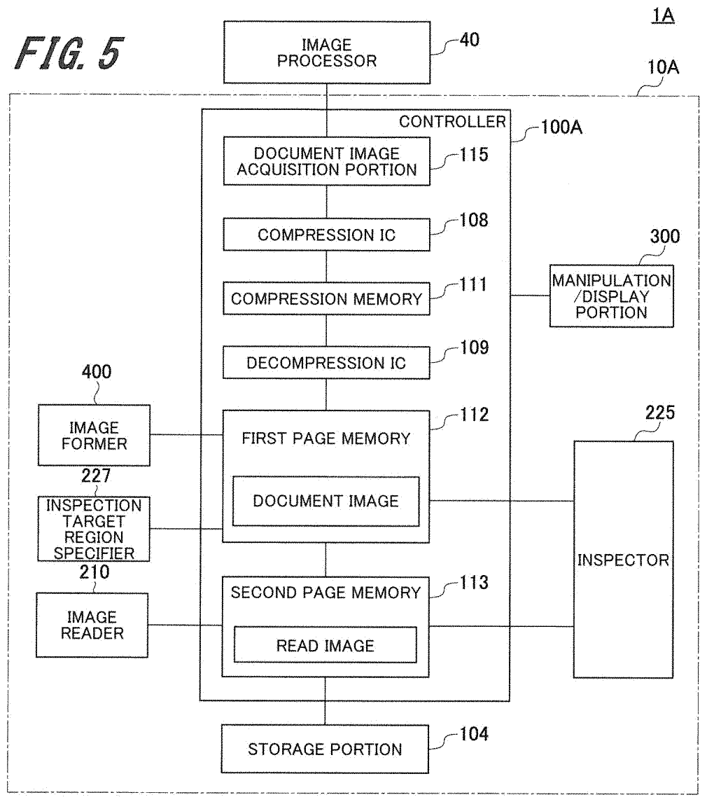

The image formation device 10 and the image inspection device 20 are configured as independent devices according to the configuration example (1) of the image formation system 1 illustrated in FIG. 4. However, the present invention is not limited thereto. The image formation device 10 may be configured to include the image inspection device 20. With reference to FIG. 5, the description below explains the configuration of an image formation system 1A as a configuration example (2) that provides the image inspection device 20 inside the image formation device 10. FIG. 5 is a function block diagram illustrating the configuration example (2) of functional parts of the image formation system 1A.

As illustrated in FIG. 5, an image formation device 10A according to the second configuration example (2) mainly includes a controller 100A, the storage portion 104, the manipulation/display portion 300, the image former 400, an inspection target region specifier 227, the image reader 210, and the inspector 225. In the image formation system 1A, the image formation device 10A includes all parts configuring the image inspection device 20.

The inspection target region specifier 227 of the image formation device 10A specifies an inspection region and an inspection-region comparable region. The inspection region is included in a document image stored in the first page memory 112. The inspection-region comparable region is included in the read image stored in a second page memory 113. Based on an instruction to start the image inspection from the controller 100A, the inspector 225 performs the image inspection by comparing an image in the inspection region for the read image with an image in the inspection-region comparable region for the document image.

Operation Example (1) of Components Configuring the Functional Part of the Image Formation System

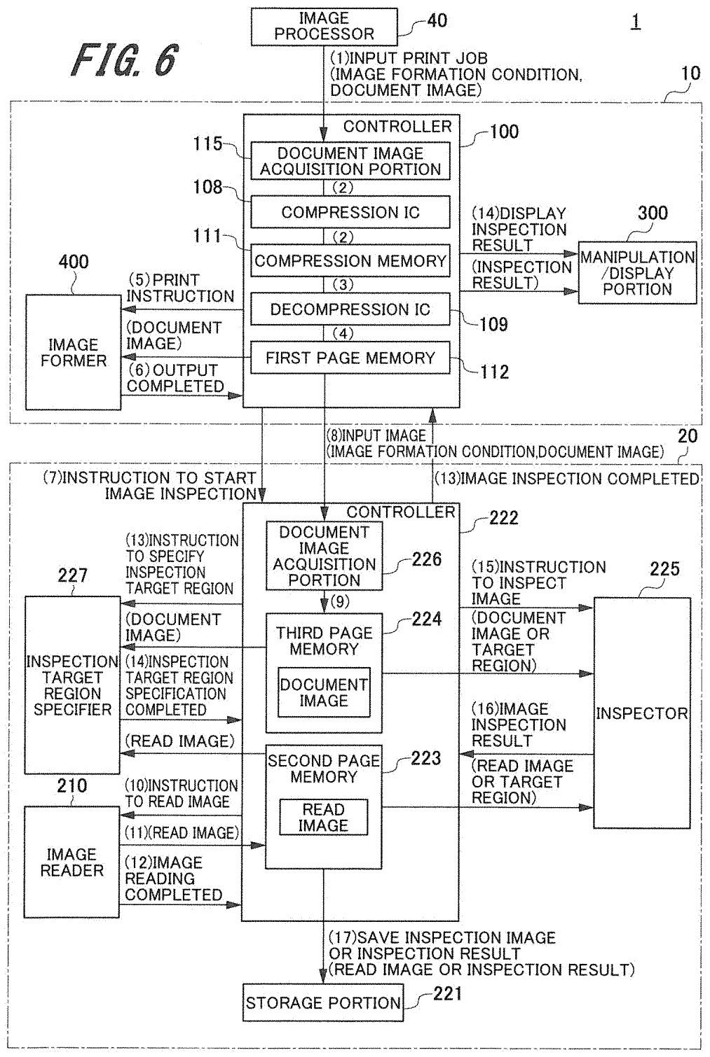

With reference to FIG. 6, the description below explains an operation example (1) of components configuring the functional part of the image formation system 1. FIG. 6 is a function block diagram illustrating the operations of components configuring the functional part of the configuration example (1) of the image formation system 1 illustrated in FIG. 4. The function blocks in FIG. 6 equal those in FIG. 4. The description below refers to processes (1) through (17) in FIG. 6 to explain how the function blocks in FIG. 4 interact with each other.

(1) The document image acquisition portion 115 acquires a print job from the image processor 40. The print job contains a document image and an image formation condition.

(2) The controller 100 starts the print job. When the print job starts, the controller 100 outputs the document image supplied from the document image acquisition portion 115 to the compression IC 108. The controller 100 stores the document image compressed by the compression IC 108 in the compression memory 111.

(3) The controller 100 outputs a compressed image stored in the compression memory 111 to the decompression IC 109.

(4) The controller 100 stores the document image decompressed by the decompression IC 109 in the first page memory 112.

(5) The controller 100 instructs the image former 400 to print the document image and transmits the document image.

(6) The image former 400 forms the document image on a sheet based on the instruction from the controller 100 and notifies the controller 100 of completion of outputting the sheet formed with the document image.

(7) The controller 100 instructs the controller 222 of the image inspection device 20 to start the image inspection.

(8) The controller 100 reads the document image stored in the first page memory 112 and outputs the document image to the image inspection device 20.

(9) The document image acquisition portion 226 of the image inspection device 20 acquires the document image supplied from the controller 100 of the image formation device 10 and stores the document image in the third page memory 224.

(10) The controller 222 of the image inspection device 20 instructs the image reader 210 to read a printed material (sheet) output from the image formation device 10.

(11) The image reader 210 reads an image formed on the sheet and stores the resulting read image in the second page memory 223.

(12) The image reader 210 notifies the controller 222 that the image reading is complete.

(13) The controller 222 instructs the inspection target region specifier 227 to specify an inspection region. Specifically, the controller 222 instructs the inspection target region specifier 227 to specify an inspection region in the read image and an inspection-region comparable region in the document image.

(14) The inspection target region specifier 227 specifies an inspection region in the read image and an inspection-region comparable region in the document image and notifies the controller 222 that the inspection region specification is complete.

(15) The controller 222 instructs the inspector 225 to inspect the image. At this time, the controller 222 outputs, to the inspector 225, the document image and the information about the inspection region and the inspection-region comparable region specified by the inspection target region specifier 227.

(16) The inspector 225 performs the image inspection by comparing an image in the inspection region for the read image with an image in the inspection-region comparable region for the document image. The inspector 225 outputs the result of the image inspection to the controller 222.

(17) The controller 222 stores the read image stored in the second page memory 223 and the result of the image inspection in the storage portion 221.

Operation Example (2) of Components Configuring the Functional Part of the Image Formation Device

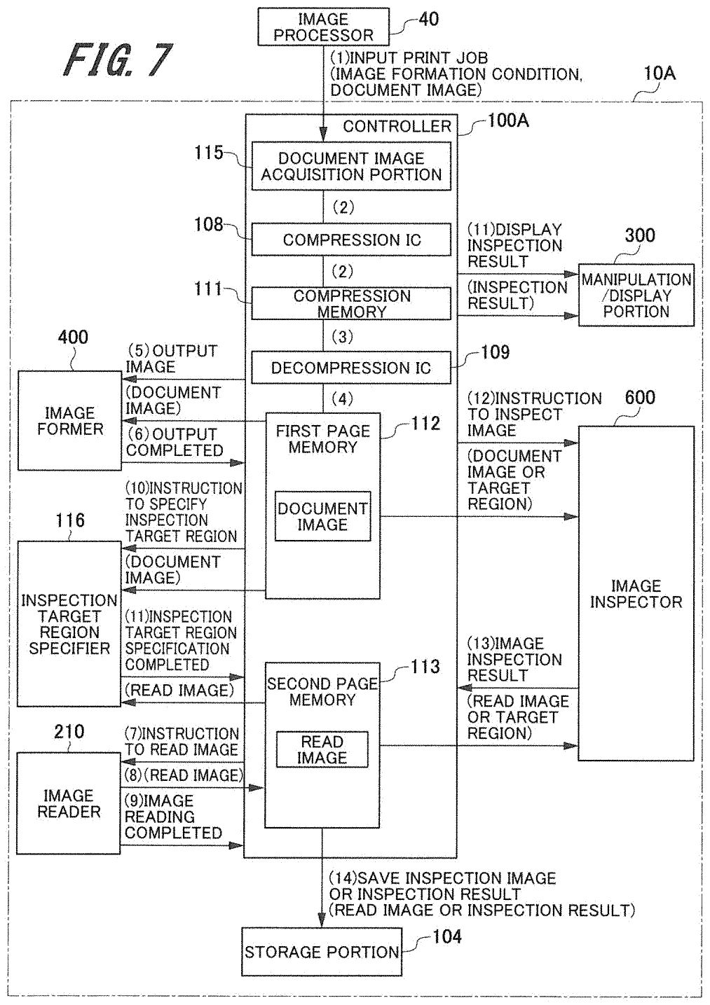

With reference to FIG. 7, the description below explains an operation example (2) of components configuring the functional part of the image formation system 1A. FIG. 7 is a function block diagram illustrating the operations of components configuring the functional part of the configuration example (2) of the image formation system 1A illustrated in FIG. 5. The function blocks in FIG. 7 equal those in FIG. 5. The description below refers to processes (1) through (14) in FIG. 7 to explain how the function blocks in FIG. 5 interact with each other.

(1) The document image acquisition portion 115 acquires a print job from the image processor 40. As above, the print job contains an image formation condition and a document image.

(2) The controller 100A starts the print job. When the print job starts, the controller 100 outputs the document image supplied from the document image acquisition portion 115 to the compression IC 108. The controller 100A stores the document image compressed by the compression IC 108 in the compression memory 111.

(3) The controller 100A outputs a compressed image stored in the compression memory 111 to the decompression IC 109.

(4) The controller 100A stores the document image decompressed by the decompression IC 109 in the first page memory 112.

(5) The controller 100A instructs the image former 400 to print the document image and transmits the document image.

(6) The image former 400 forms the document image on a sheet based on the instruction from the controller 100 and notifies the controller 100A of completion of outputting the sheet formed with the document image.

(7) The controller 100A instructs the image reader 210 to read a printed material (sheet) output from the image former 400.

(8) The image reader 210 reads an image formed on the sheet and stores the resulting read image in the second page memory 113.

(9) The image reader 210 notifies the controller 100A that the image reading is complete.

(10) The controller 100A instructs the inspection target region specifier 227 to specify an inspection region. Specifically, the controller 100A instructs the inspection target region specifier 227 to specify an inspection region in the read image and an inspection-region comparable region in the document image.

(11) The inspection target region specifier 227 specifies an inspection region in the read image and an inspection-region comparable region in the document image and notifies the controller 100A that the inspection region specification is complete.

(12) The controller 100A instructs the inspector 225 to inspect the image. At this time, the controller 100A outputs, to the inspector 225, the document image and the information about the inspection region and the inspection-region comparable region specified by the inspection target region specifier 227.

(13) The inspector 225 performs the image inspection by comparing an image in the inspection region for the read image with an image in the inspection-region comparable region for the document image. The inspector 225 outputs the result of the image inspection to the controller 100A.

(14) The inspector 225 stores the read image stored in the second page memory 113 and the result of the image inspection in the storage portion 104.

Example of Specifying the Inspection Region and the Inspection-Region Comparable Region Using the Inspection Target Region Specifier

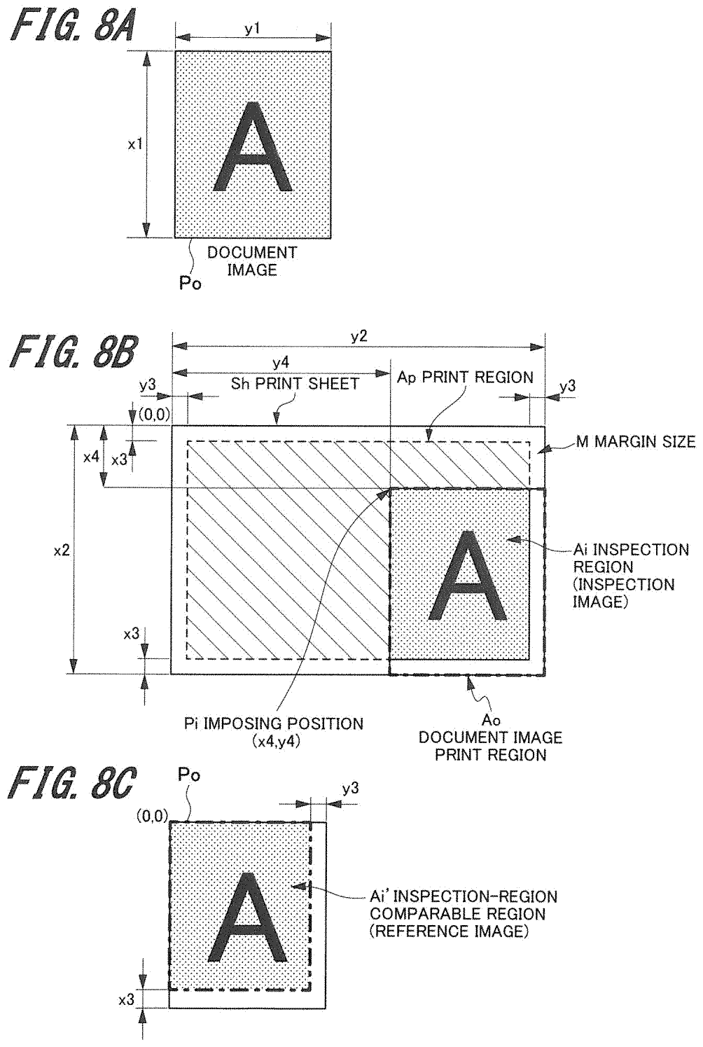

With reference to FIGS. 8A to 8C, the description below explains an example of specifying the inspection region and the inspection-region comparable region using the inspection target region specifier 227. FIGS. 8A to 8C are diagrams illustrating how the inspection target region specifier 227 specifies the inspection region and the inspection-region comparable region.

FIG. 8A shows an example of document image Po. It is supposed that “x1” denotes the size of document image Po in the horizontal scanning direction and “y1” denotes the size of the same in the vertical scanning direction.

FIG. 8B illustrates a print image as document image Po formed on sheet Sh. It is supposed that “x2” denotes the size of sheet Sh in the horizontal scanning direction and “y2” denotes the size of the same in the vertical scanning direction. It is supposed that “x3” denotes the margin size in the horizontal scanning direction and “y3” denotes the margin size in the vertical scanning direction as specified in the image formation condition. It is supposed that document image Po is printed on sheet Sh at the position (x4, y4), namely, the position shifted “x4” in the horizontal scanning direction and shifted “y4” in the vertical scanning direction from the origin (0, 0) at the top left of sheet Sh as specified in the image formation condition.

When document image Po is positioned at the origin on sheet Sh before image editing (before the imposition on sheet Sh), the region for document image Po is positioned on sheet Sh at:

Top left coordinate=(0, 0)

Bottom right coordinate=(x1, y1)

The inspection target region specifier 227 then calculates the position of a region for document image Po on sheet Sh after image editing (after the imposition on sheet Sh). After the image editing, the region for document image Po is positioned on sheet Sh so that the document image region is shifted from the origin (0, 0) by the shift amount specified in the image formation condition to satisfy the following coordinates.

Top left coordinate=(x4, y4) (=imposing position Pi) Bottom right coordinate=(x1+x4, y1+y4)

The inspection target region specifier 227 calculates the position of print region Ap on sheet Sh. The print region is used to form an image on sheet Sh and excludes a trimming region. Print region Ap is hatched in the drawing. Print region Ap is positioned on sheet Sh to shift inside by the margin size (x3, y3) from the edge of sheet Sh. The following coordinates represent the position.

Top left coordinate=(x3, y3)

Bottom right coordinate=(x2-x3, y2-y3)

The inspection target region specifier 227 calculates inspection region Ai in a read image read by the image reader 210. Inspection region Ai in the read image corresponds to an overlap between document image print region Ao and print region Ap on sheet Sh. The position to form document image print region Ao can be calculated based on the image formation condition.

The upper left coordinate of inspection region Ai corresponds to the upper left coordinate of document image print region Ao or the upper left coordinate of print region Ap, whichever contains a larger value. The bottom right coordinate of inspection region Ai corresponds to the top left coordinate of document image print region Ao or the top left coordinate of print region Ap, whichever contains a smaller value.

According to the example of FIG. 8B, document image print region Ao shows a larger value for the upper left coordinate. Print region Ap shows a smaller value for the bottom right coordinate. Therefore, the following coordinates represent the position of inspection region Ai.

Top left coordinate=(x4, y4)

Bottom right coordinate=(x2-x3, y2-y3)

The inspection target region specifier 227 calculates inspection-region comparable region Ai′ in document image Po. As illustrated in FIG. 8C, inspection-region comparable region Ai′ is acquired by eliminating the margin size (x3, y3) to be trimmed from document image Po. Therefore, the following coordinates represent the position of inspection-region comparable region Ai′.

Top left coordinate=(0, 0)

Bottom right coordinate=(x1-x3, y1-y3)

The inspector 225 identifies an inspection image and a reference image. The inspection image is contained in inspection region Ai for the read image specified by the inspection target region specifier 227. The reference image is contained in inspection-region comparable region Ai′ for document image Po. The inspector 225 compares the inspection image with the reference image to perform the image inspection to determine whether the inspection image is normal.

Example of the Image Formation Condition

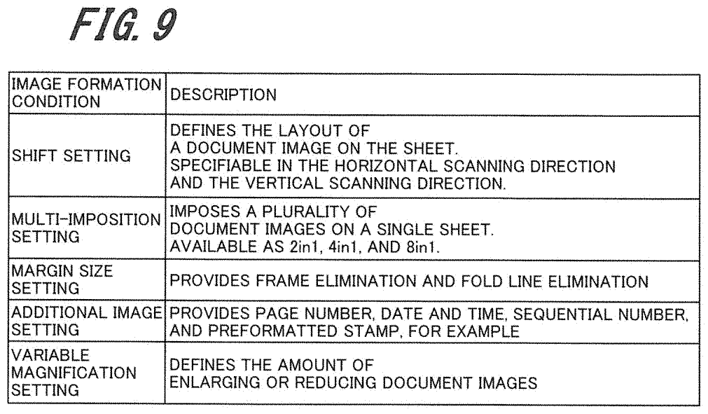

With reference to FIG. 9, the description below explains an example of the image formation condition. FIG. 9 is a table illustrating the image formation condition. As illustrated in FIG. 9, the image formation condition includes “shift setting,” “multi-imposition setting,” “margin size setting,” “additional image setting,” and “variable magnification setting,” for example.

The “shift setting” defines the layout of a document image on sheet Sh and is applicable to both the horizontal scanning direction and the vertical scanning direction. The “multi-imposition setting” imposes a plurality of document images on a single sheet Sh and provides 2in1, 4in1, and 8in1, for example. The “margin size setting” defines a margin size provided for sheet Sh and provides frame elimination and fold line elimination, for example.

The “additional image setting” defines the contents of an image added to sheet Sh and the position of the additional image. The additional image includes a page number, date and time, sequential number, and preformatted stamp, for example. The “variable magnification setting” defines the amount of enlarging or reducing document images.

According to the present embodiment, the inspector 225 compares the inspection image in the inspection region with the reference image in the inspection-region comparable region specified by the inspection target region specifier 227 even when the image formation condition is enabled. According to the present embodiment, an ASIC, for example, implements image processing or editing to be capable of the image inspection even in a configuration where, for example, the memory does not save the print image subject to image processing or image editing such as the imposition.

Method of Specifying the Inspection Region and the Inspection-Region Comparable Region when a Document Image and a Read Image are Differently Oriented

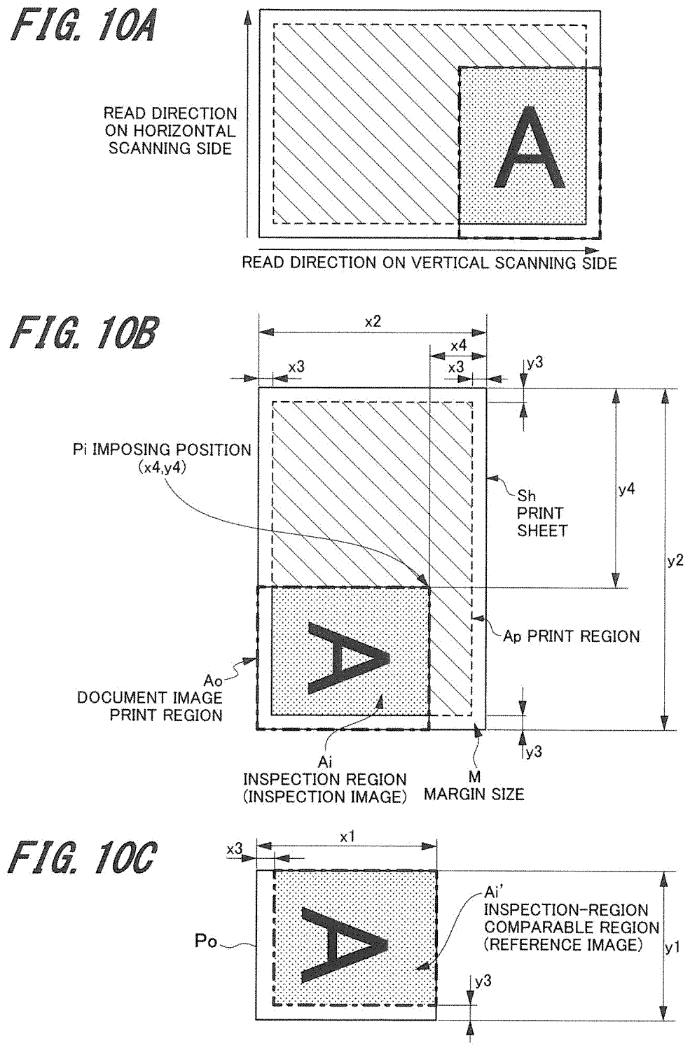

A read image read by the image reader 210 and a document image may be differently oriented depending on the orientation of sheet Sh placed in the large-capacity paper feeder 5 and the orientation of the document image specified in the image formation condition. In such a case, the inspection target region specifier 227 specifies the inspection region and the inspection-region comparable region based on a method to be described with reference to FIGS. 10A to 10C. FIGS. 10A to 10C are diagrams illustrating a method of specifying the inspection region and the inspection-region comparable region when a document image and a read image are differently oriented.

FIG. 10A illustrates directions in which the image reader 210 reads sheet Sh. As illustrated in FIG. 10A, sheet Sh is read from left to right (from bottom to top in the drawing) in the horizontal scanning direction and is read from top to bottom (from left to right in the drawing) in the vertical scanning direction.

FIG. 10B illustrates a read image read by the image reader 210. When the image reader 210 reads sheet Sh in the direction illustrated in FIG. 10A, the read image is oriented to rotate 90 degrees with respect to the orientation of the document image. The document image and the read image are differently oriented and therefore cannot be compared with each other. To solve this, the inspection target region specifier 227 rotates the orientation of the document image 90 degrees so that the document image and the read image are equally oriented. Then, the inspection-region comparable region is specified in the document image.

FIG. 10C shows that the orientation of the document image is rotated 90 degrees. As illustrated in FIG. 10C, the inspection target region specifier 227 rotates the orientation of document image Po 90 degrees and then specifies inspection-region comparable region Ai′ by eliminating the margin from document image Po.

For example, when the image formation condition specifies the binding direction of sheet Sh to be upward, an image on the reverse side of sheet Sh results from rotating an image on the face thereof 180 degrees. In this case, the inspection target region specifier 227 rotates the orientation of the document image 180 degrees and then specifies the inspection-region comparable region in the document image.

According to the present embodiment, the inspector 225 can perform the image inspection even when the read image and the document image are differently oriented. The ASIC for image processing generally includes the function to rotate images. Therefore, the present embodiment can perform the image inspection without forming a print image in the memory even when the read image and the document image are differently oriented.

Example of Specifying the Inspection-Region Comparable Region when a Plurality of Document Images Overlap on a Sheet

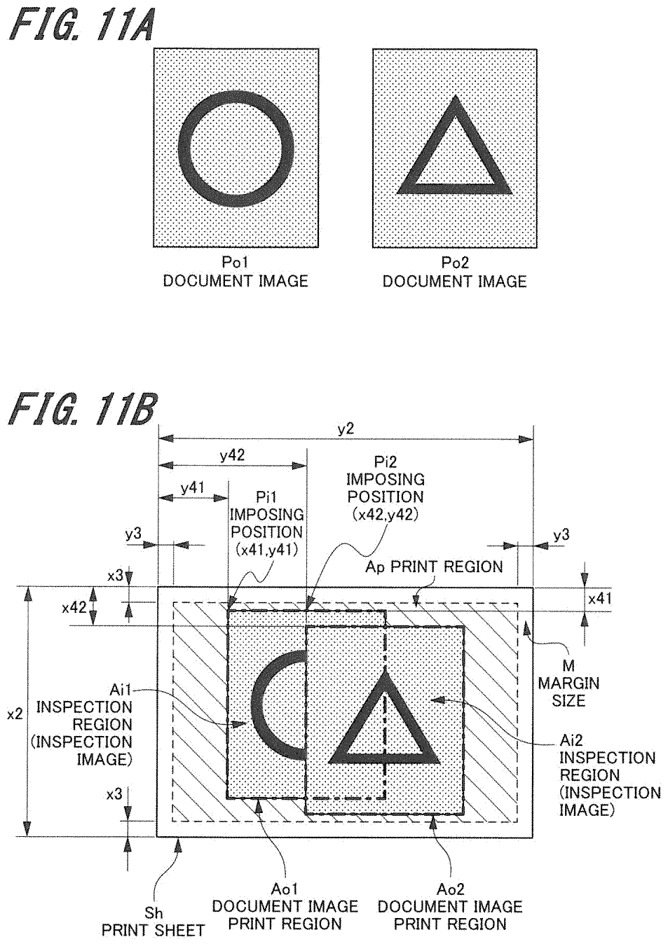

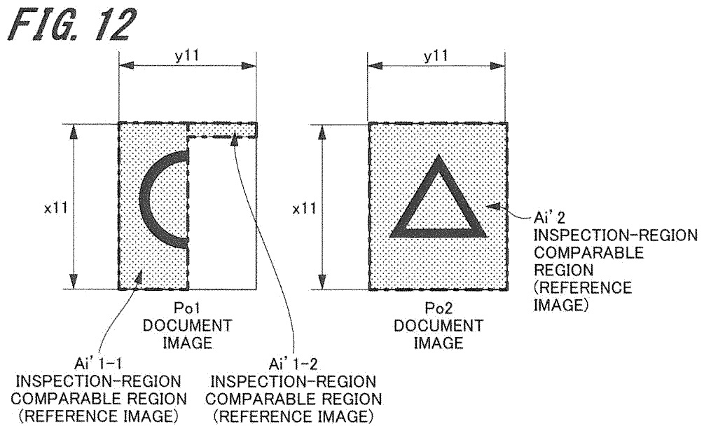

With reference to FIGS. 11 and 12, the description below explains an example of specifying the inspection-region comparable region when a plurality of document images overlap. FIGS. 11A and 11B show an example of overlapping a plurality of document images on sheet Sh. FIG. 12 illustrates how the inspection target region specifier 227 specifies the inspection-region comparable region.

FIG. 11A shows two document images Po1 and Po2. Document image Po1 includes a circle. Document image Po2 includes a triangle.

FIG. 11B illustrates a situation where document image Po2 overlaps document image Po1 on sheet Sh. This placement conforms to the following image formation condition.

(1) Shift Setting for Positions to Print (Generate) a Document Image:

Document image Po1 shifts by “x41” in the horizontal scanning direction and shifts by “y41” in the vertical scanning direction. Document image Po2 shifts by “x42” in the horizontal scanning direction and shifts by “y42” in the vertical scanning direction. The image formation condition assumes that “x42” is larger than “x41” and “y42” is larger than “y41.”

(2) Multi-Imposition Setting: 2In1

The document images are imposed based on the image formation conditions (1) and (2). Then, document images Po1 and Po2 are positioned to overlap with each other and are fit into print region Ap. Specifications of the image formation device 10 define which of document images Po1 and Po2 is placed over the other. According to the present embodiment, the description below is based on a specification that document image Po2 as a succeeding page overwrites document image Po1 as a preceding page.

In FIG. 12, document image Po1 to be overwritten is shown on the left and overwriting document image Po2 is shown on the right. Overwriting document image Po2 is not overwritten by the other document images and therefore equals the original document image. Document image Po1 to be overwritten contains a hidden region corresponding to overlap with document image Po2 that is placed over document image Po1.

According to the present embodiment, the inspection target region specifier 227 excludes the part of the region hidden by the overwriting document image, namely, the overlap with the overwriting document image, from the inspection target and specifies the region after the exclusion as the inspection-region comparable region.

As illustrated in FIG. 12, the region after excluding the hidden part is divided into inspection-region comparable regions Ai′1_1 and Ai′1_2. Inspection-region comparable region Ai′1_1 is positioned to the left of the left side of overwriting document image Po2. Inspection-region comparable region Ai′1_2 is positioned to the right of the same. The inspector 225 performs the image inspection on each of inspection-region comparable regions Ai′1_1 and Ai′1_2 individually.

The present embodiment provides the example of dividing the inspection-region comparable region into two regions in document image Po1 to be overwritten. However, the present invention is not limited thereto. The inspector 225 may perform the image inspection on the inspection-region comparable region comprised of inspection-region comparable regions Ai′1_1 and Ai′1_2.

Example of Specifying the Inspection Region when an Additional Image is Attached

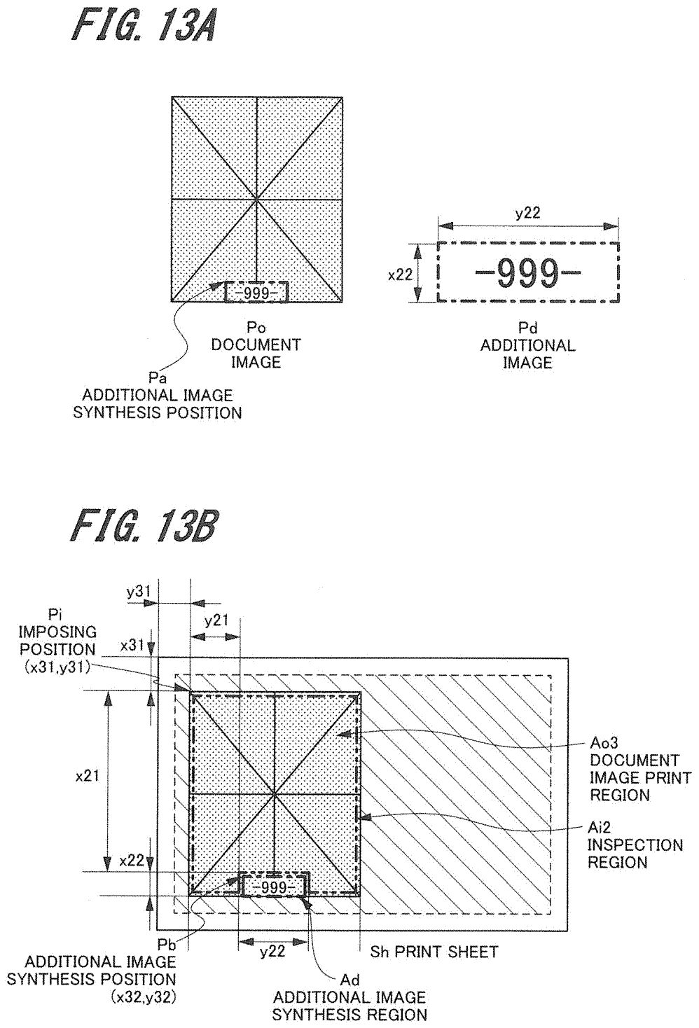

With reference to FIGS. 13A and 13B, the description below explains an example of how the inspection target region specifier 227 specifies an inspection region when the image formation condition specifies attachment of additional images such as a page number and date and time. FIGS. 13A and 13B show an example of specifying the inspection region when an additional image is attached. FIG. 13A shows document image Po and additional image Pd. FIG. 13B shows a read image of printout sheet Sh to print document image Po combined with additional image Pd.

As illustrated in FIG. 13A, additional image Pd is provided as “-999-” comprised of symbols and numbers. Additional image Pd is attached to document image Po at synthesis position Pa (hereinafter described as an additional image synthesis position) corresponding to the coordinate of additional image Pd at the top left. The additional image synthesis position is assumed to be (x21, y21). The size of additional image Pd is represented as “x22” in the horizontal scanning direction and “y22” in the vertical scanning direction.

When additional image Pd and document image Po are synthesized and printed, document image Po not synthesized with additional image Pd differs from the read image containing additional image Pd in the contents. Therefore, it is impossible to directly compare document image Po with the read image (inspection image).

According to the present embodiment, as illustrated in FIG. 13B, the inspection target region specifier 227 excludes additional image synthesis region Ad in document image print region Ao3 for the read image on sheet Sh from the inspection region. Additional image synthesis region Ad is used to print additional image Pd on sheet Sh when imposing position Pi of the document image corresponds to the top-left end of document image Po. The position to form additional image synthesis region Ad depends on additional image synthesis position Pb and the size of additional image Pd in document image print region Ao3.

Additional image synthesis position Pb in document image print region Ao3 corresponds to an offset of additional image synthesis position Pa (see FIG. 13A) illustrated in FIG. 13A from imposing position Pi of the document image.

As preconditions, additional image synthesis position Pa corresponds to coordinate (x21, y21) in the document image. The size of additional image region Pd is represented as “x22” in the horizontal scanning direction and “y22” in the vertical scanning direction. Imposing position Pi corresponds to coordinate (x31, y31) in the document image. In this case, additional image synthesis position Pb in document image print region Ao3 corresponds to coordinate (x21+x31, y21+y31) at the top-left end of additional image synthesis region Ad. The bottom-right end of additional image synthesis region Ad corresponds to coordinate (x21+x31+x22, y21+y31+y22).

The inspection target region specifier 227 specifies an inspection region, namely, a region Ai2 surrounded by a frame indicated by a dash-dot-dot-dash line in FIG. 13B resulting from excluding additional image synthesis region Ad from document image print region Ao3. The inspection target region specifier 227 performs this process to be capable of the image inspection by using the reference image comparable to document image Po and an inspection image comparable to an image in inspection region Ai2 of the read image even when the image formation condition specifies attachment of additional image Pd.

Example of the Image Inspection when an Additional Image is Attached

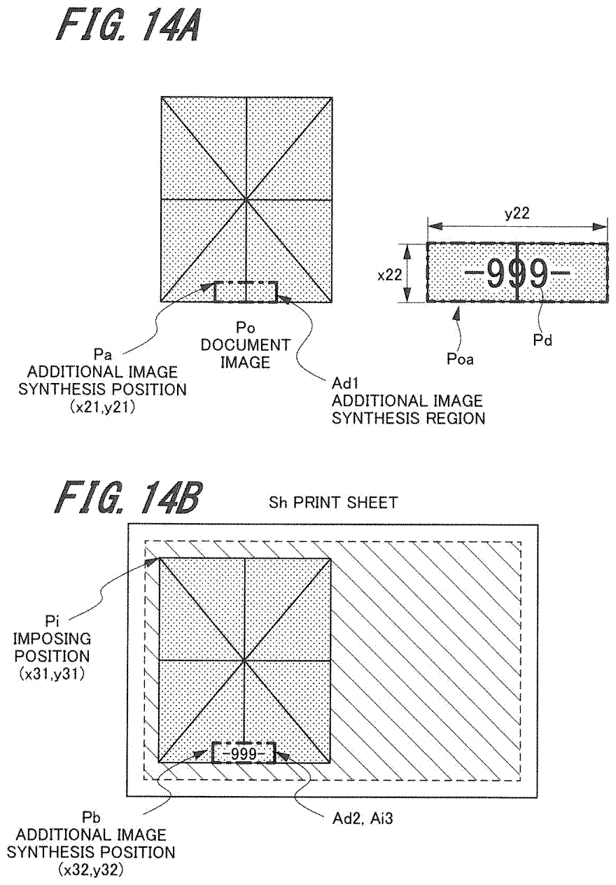

With reference to FIGS. 14A and 14B, the description below explains an example of how the inspector 225 performs an inspection when the image formation condition specifies attachment of an additional image. According to the example in FIGS. 14A and 14B unlike the example in FIGS. 13A and 13B, the inspector 225 generates a synthetic image synthesized with an additional image.

FIGS. 14A and 14B illustrate the image inspection when an additional image is attached. FIG. 14A shows document image Po and additional image synthetic image Poa resulting from synthesizing additional image synthesis region Ad1 for the document image with additional image Pd. FIG. 14B shows a read image of printout sheet Sh where document image Po synthesized with additional image Pd is printed.

The inspector 225 extracts additional image synthesis region Ad1 from document image Po indicated by a dash-dot-dash line in FIG. 14A and writes an image in the extracted additional image synthesis region Ad1 to any area in the image memory 110 (see FIG. 3). The inspector 225 synthesizes additional image Pd with the extracted additional image synthesis region Ad1 to generate additional image synthetic image Poa as a print image.

The inspection target region specifier 227 specifies additional image synthesis region Ad2 as a region to print additional image Pd on sheet Sh and defines this region as inspection-region comparable region Ai3. The inspector 225 uses the reference image represented by additional image synthetic image Poa, uses the inspection image represented by an image in inspection-region comparable region Ai3, and compares the reference image with the inspection image to perform the image inspection.

The example in FIGS. 14A and 14B can compare additional image synthetic image Poa as the reference image with the image in inspection-region comparable region Ai3 even when the image formation condition specifies attachment of additional image Pd. A print image is generated only in additional image synthesis region Ad1, making it possible to minimize an increase in the processing time due to generation of the print image and accelerate the image inspection.

Image Inspection Method Provided by the Image Formation System

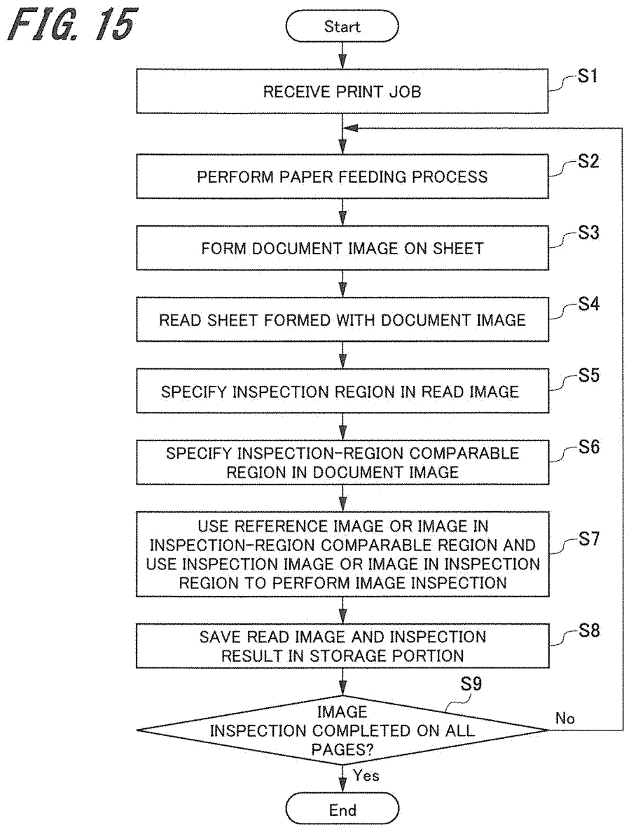

With reference to FIG. 15, the description below explains the image inspection method provided by the image formation system 1. FIG. 15 is a flowchart illustrating a procedure of the image inspection method provided by the image formation system 1.

The document image acquisition portion 115 (see FIG. 4) of the image formation device 10 receives a print job from the image processor 40 (step S1). The print job received in step S1 includes the image formation condition and a document image. When starting the received print job, the controller 100 outputs the document image supplied from the document image acquisition portion 115 to the compression IC 108 to compress the document image. The controller 100 stores the compressed document image in the compression memory 111. The controller 100 outputs the compressed image stored in the compression memory 111 to the decompression IC 109 to decompress the compressed image. The controller 100 stores the decompressed document image in the first page memory 112.

The image formation device 10 performs a paper feeding process (step S2). The large-capacity paper feeder 5 thereby supplies sheet Sh into the image formation device 10. The image former 400 forms the document image on sheet Sh based on the image formation condition received in step S1 (step S3).

The image reader 210 reads sheet Sh formed with the document image (step S4), and stores the read image acquired by reading in the second page memory 223. The inspection target region specifier 227 specifies an inspection region in the read image (step S5). The inspection target region specifier 227 specifies an inspection-region comparable region in the document image (step S6).

The inspector 225 uses the inspection image represented by an image in the inspection region and uses the reference image represented by an image in the inspection-region comparable region to perform the image inspection (step S7). The inspector 225 saves the read image acquired by the image reader 210 in step S4 and an inspection result of the image inspection performed by the inspector 225 in step S7 in the storage portion 104 or the storage portion 221 (step S8). The controller 100 determines whether the image inspection is complete on all pages contained in the print job (step S9). If it is determined in step S9 that the image inspection is not complete on all pages (NO in step S9), the controller 100 returns the process to step S2. If it is determined in step S9 that the image inspection is complete on all pages (YES in step S9), the controller 100 terminates the image inspection process.

According to the above-described embodiment, the inspection target region specifier 227 specifies a print region on sheet Sh based on the image formation condition for the document image and specifies an inspection region for reading based on the specified print region. The inspector 225 compares an image in the inspection region specified by the inspection target region specifier 227 with an image in the inspection-region comparable region corresponding to the inspection region for the document image to perform the image inspection. Therefore, the present embodiment can perform the image inspection even when the image formation device 10 performs image processing or image editing.

According to the above-described embodiment, the image formation condition contains at least one of layout position setting of a document image on a recording material, trimming amount setting for a document image when formed on sheet Sh, attachment setting of an additional image, and variable magnification setting of a document image. Based on the image formation condition according to the present embodiment, the inspection target region specifier 227 can specify the inspection region and the inspection-region comparable region where the inspector 225 performs the image inspection. According to the present embodiment, the inspector 225 can perform the image inspection even when the image former 400 performs image processing or image editing and no print image is saved in the memory, for example.

According to the above-described embodiment, the inspection target region specifier 227 calculates the inspection region in the read image based on the information about a document image region to place the document image on sheet Sh and the information about the print region to form an image on sheet Sh. The inspection target region specifier 227 calculates the inspection-region comparable region based on the calculated inspection region and the information about the layout position of the document image on sheet Sh. Based on the information specified in the image formation condition according to the present embodiment, the inspection target region specifier 227 can specify the inspection region and the inspection-region comparable region where the inspector 225 performs the image inspection. According to the present embodiment, the inspector 225 can perform the image inspection even when the image formation controller 402 performs image processing or image editing and no print image is saved in the memory, for example.

When there is a case where the document image and the read image are differently oriented according to the above-described embodiment, the inspection target region specifier 227 rotates the document image so that the document image and the inspection image are equally oriented. The inspection target region specifier 227 then specifies the inspection region in the rotated document image. According to the present embodiment, the inspector 225 can perform the image inspection without allowing the image former 400 to generate a print image even when the document image and the read image are differently oriented.

When the image formation condition specifies a layout of a plurality of document images on sheet Sh and inspection regions of the document images overlap, according to the above-described embodiment, the inspection target region specifier 227 excludes the inspection region in the overwriting document image from the inspection region in the document image to be overwritten. According to the present embodiment, the inspector 225 can perform the image inspection without allowing the image former 400 to generate a print image even when the inspection regions of the document images overlap.

When the image formation condition specifies the synthesis of an additional image, according to the above-described embodiment, the inspection target region specifier 227 specifies a synthesis region for the additional image in the inspection region and does not inspect the specified synthesis. According to the present embodiment, the inspector 225 can perform the image inspection without allowing the image former 400 to generate a print image even when the image formation condition specifies the synthesis of an additional image.

According to the present embodiment, the inspector 225 extracts the synthesis region specified by the inspection target region specifier 227. The inspector 225 synthesizes the extracted synthesis region with the additional image and compares an image synthesized with the additional image with an image in the region corresponding to a region to be inspected. According to the present embodiment, the inspector 225 can perform the image inspection even when the image formation condition specifies the synthesis of an additional image.

Modifications

The present invention is not limited to the above-mentioned embodiments. It is further understood by those skilled in the art that various applications and modifications may be made in the present invention without departing from the spirit and scope thereof described in the appended claims.

For example, the above-mentioned embodiments describe, in detail and specifically, configurations of the apparatuses and the system in order to explain the present invention for simplicity but are not limited to an entity including all the configurations that have been described. The configuration of the embodiment can be partially subject to addition, deletion, or replacement of another configuration. The control lines or the information lines are provided on the condition that they are considered necessary for the sake of description. The description does not cover all control lines or information lines as products. Practically, almost all the configurations can be interconnected.

### REFERENCE SIGNS LIST

1, 1A . . . image formation system, 10, 10A . . . image formation device, 20 . . . image inspection device, 21 . . . controller, 40 . . . image processor, 100, 100A . . . controller, 104 . . . storage portion, 105 . . . read processor, 106 . . . write processor, 107 . . . control IC, 110 . . . image memory, 111 . . . compression memory, 112 . . . first page memory, 113 . . . second page memory, 115 . . . document image acquisition portion, 124 . . . image reader, 210 . . . image reader, 220 . . . image inspector, 221 . . . storage portion, 222 . . . controller, 223 . . . second page memory, 224 . . . third page memory, 225 . . . inspector, 226 . . . document image acquisition portion, 227 . . . inspection target region specifier, 300 . . . manipulation/display portion, 400 . . . image former, 402 . . . image formation controller

1. An image inspection device comprising:
an image reader that reads a recording material formed with a document image based on an image formation condition to acquire a read image;
a document image acquisition portion that acquires the document image;
an inspection target region specifier that specifies a print region on a recording material based on an image formation condition for the document image acquired by the document image acquisition portion and specifies an inspection region in the read image based on the specified print region; and
an image inspector that compares an image in the inspection region specified by the inspection target region specifier with an image in the inspection-region comparable region corresponding to the inspection region in the document image to perform image inspection on the read image.

2. The image inspection device according to claim 1,
wherein the image formation condition includes at least one of layout position setting of the document image on the recording material, trimming amount setting for the document image when formed on the recording material, attachment setting of an additional image, and variable magnification setting of the document image.

3. The image inspection device according to claim 2,
wherein the inspection target region specifier calculates the inspection region in the read image based on information about a document image region to place the document image on the recording material and information about a print region to form an image on the recording material and calculates the inspection-region comparable region based on information about a layout position on the recording material for the document image.

4. The image inspection device according to claim 1,
wherein the image inspector uses an inspection image corresponding to an image in the inspection region specified by the inspection target region specifier and uses a reference image corresponding to an image in the inspection-region comparable region specified by the inspection target region specifier.

5. The image inspection device according to claim 4,
wherein, when the document image and the read image are differently oriented, the inspection target region specifier rotates the document image to equally orient the document image and the inspection image and specifies an inspection region in the rotated document image.

6. The image inspection device according to claim 1,
wherein, when the image formation condition specifies layout of a plurality of the document images on the recording material and specifies an overlap of inspection regions for the document images, the inspection target region specifier excludes the inspection region in the overwriting document image from the inspection region in the document image to be overwritten.

7. The image inspection device according to claim 1,
wherein, when the image formation condition specifies synthesis of an additional image, the inspection target region specifier specifies a synthesis region for the additional image in the inspection region and does not inspect the specified synthesis.

8. The image inspection device according to claim 1,
wherein, when the image formation condition specifies synthesis of an additional image, the inspection target region specifier specifies a synthesis region for the additional image in the inspection region; and
wherein the image inspector extracts the synthesis region specified by the inspection target region specifier, synthesizes the additional image with the extracted synthesis region, and compares an image synthesized with the additional image with an image in a region corresponding to the synthesis region in the region targeted at the inspection.

9. An image formation device comprising:
an image former that forms a document image on a recording material based on an image formation condition;
an image reader that reads a recording material formed with an image formed by the image former to acquire a read image;
a document image acquisition portion that acquires the document image;
an inspection target region specifier that specifies a print region on the recording material based on an image formation condition for the document image acquired by the document image acquisition portion and specifies an inspection region in the read image based on the specified print region; and
an image inspector that compares an image in the inspection region specified by the inspection target region specifier with an image in the inspection-region comparable region corresponding to the inspection region in the document image to perform image inspection on the read image.

10. An image inspection method comprising:
reading a recording material formed with a document image based on an image formation condition to acquire a read image;
acquiring the document image;
specifying a print region on the recording material based on an image formation condition for the acquired document image and specifying an inspection region in the read image based on the specified print region; and
comparing an image in the specified inspection region with an image in the inspection-region comparable region corresponding to the inspection region in the document image to perform image inspection on the read image.

11. A non-transitory computer readable recording medium storing a program causing a computer to perform:
reading a recording material formed with a document image based on an image formation condition to acquire a read image;
acquiring the document image;
specifying a print region on the recording material based on an image formation condition for the acquired document image and specifying an inspection region in the read image based on the specified print region; and
comparing an image in the specified inspection region with an image in the inspection-region comparable region corresponding to the inspection region in the document image to perform image inspection on the read image.
